(19) United States
(12) Patent Application Publication
(10) Pub. No.: US 2006/0242693 A1
(43) Pub. Date: Oct. 26, 2006

(54) ISOLATED AUTHENTICATION DEVICE AND ASSOCIATED METHODS

(76) Inventor: John Wesley Kussmaul, Weston, MA (US)

Correspondence Address: W. EDWARD RAMAGE, COMMERCE CENTER SUITE 1000, 211 COMMERCE ST, NASHVILLE, TN, 37201, US

(21) Appl. No.: 11/379,613

(22) Filed: Apr. 21, 2006

Related U.S. Application Data
(60) Provisional application No. 60/674,145, filed on Apr. 22, 2005.

(51) Int. Cl. H04L 9/32

(52) U.S. Cl. 726/9

(57) ABSTRACT

An isolated authentication device and related methods to provide a reliable means of authenticating the identity of its user to a network resource or server, and of authenticating the identity of a network resource or server to the device's user. The isolated authentication device may be attached to or in communication with a host device, such as a mobile telephone, personal digital or data assistant, GPS multifunction device, portable music player, wristband watch, personal computer, or similar device. A constrained operating system provides limited functionality, including authentication, data transfer, and cryptographic functions. Encrypted image, fingerprint, password, and/or personal identification number data is stored in read-only or protected nonvolatile memory. Input may be provided by means of a numeric or alphanumeric keypad, and images and information may be displayed on a screen.

This application claims benefit of the previously filed Provisional Patent Application No. 60/674,145, filed Apr. 22, 2005 by John Wesley Kussmaul, and is entitled to that filing date for priority. The specification and drawings of Provisional Patent Application No. 60/674,145 are incorporated herein by specific reference.

### FIELD OF INVENTION

This invention relates to a device and method for user authentication. More particularly, the present invention relates to a device and associated methods for authenticating the identity of a user to a network resource and for authenticating the identity of a network resource to the device's user.

### BACKGROUND OF INVENTION

The problem of authentication of parties doing business or communicating over the Internet or similar networks is well known. A variety of false or spoofed web sites have been used to deceive and defraud various users that the site is a site for a genuine business when it really is not. Similarly, a user can pretend to be someone other than they are, often using purloined passwords, personal identification numbers (PINs), or similar identifiers.

Some web sites provide some form of certificate to allow a user to verify that a web site is authentic, or place a certificate or cookie on the user's computer to prove their authenticity. However, the procedures for performing this form of authentication can be complex and unwieldy, and too difficult to use for most individuals. Gasparini, et al. (U.S. patent application Ser. No. 10/435,322) discloses a method of using a signed, encrypted cookie on the user's system to allow a web site to authenticate a user. However, such a system may still be vulnerable to the cookie being copied or duplicated, and is limited to particular systems using cookies.

Thus, what is needed is a independent authentication device that connects to or communicates with a variety of systems or host devices, and can easily and accurately authenticate a web site or server to a user, and vice versa, without storing any security data or cookie on the user's system or host device.

### SUMMARY OF THE INVENTION

The present invention relates to a device and related methods for providing an independent authentication device that connects to or communicates with a variety of host devices or systems. The authentication device can securely authenticate the user to a web site or server, and conversely, securely authenticate a web site or server to a user. Encrypted data, which may include an image file, fingerprint or biometric data, passwords, and/or PINs, and asymmetric key data, are stored in protected nonvolatile memory in the authentication device. Certain pieces of this data may be provided to a web site or server, and used in the authentication procedures.

### DESCRIPTION OF THE DRAWINGS

FIG. 1 shows a top and side view of one embodiment of the present invention with a USB connector.

FIG. 2 shows a top and side view of another embodiment of the present invention with wireless connection.

FIG. 3 shows a top view of another embodiment of the present invention with a numeric keypad.

FIG. 4 shows a top view of the interior of another embodiment of the present invention.

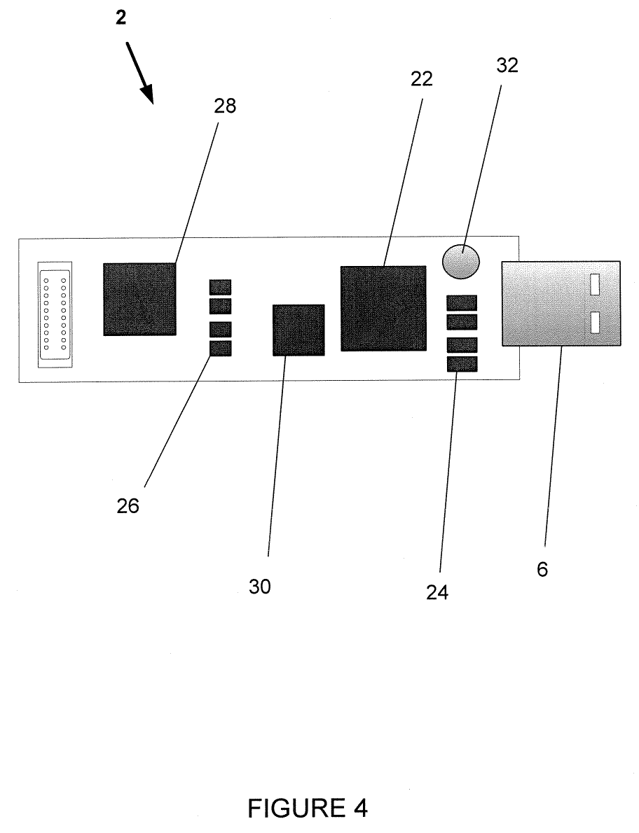

FIG. 5 shows various steps in the process of initiating an authentication device in accordance with an embodiment of the present invention.

FIG. 6 shows various steps in the use of an authentication device in accordance with an embodiment of the present invention.

### DESCRIPTION OF THE INVENTION

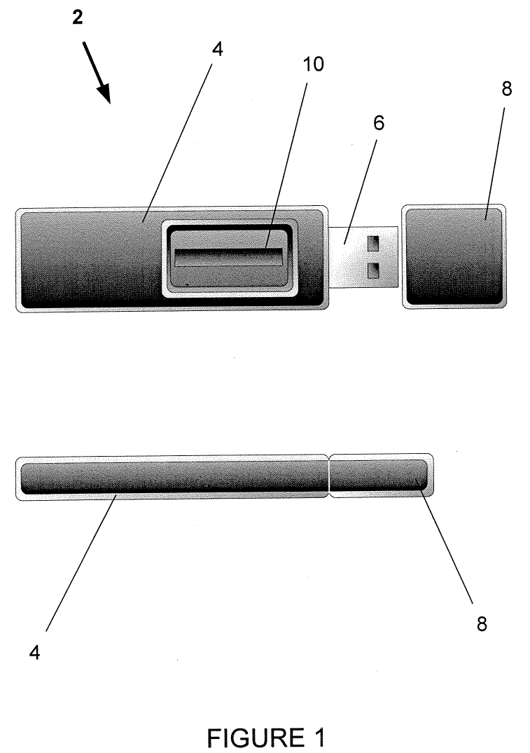

Referring now to the numerous figures, wherein like references identify like elements of the invention, FIG. 1 shows an isolated authentication device 2 in accordance with one exemplary embodiment of the present invention. The isolated authentication device 2 may be of any size and shape. In various exemplary embodiments, as seen in FIGS. 1-3, the device may be about the size and shape of a Universal Serial Bus (USB) memory stick or key chain, a smart card, a credit card, or a small calculator. In general, the isolated authentication device 2 comprises a shell 4, and external or internal connection or communications means 6. A cap 8 may be used, when appropriate, to cover the connection means (such as the USB connector shown in FIG. 1).

The device 2 also may incorporate or be attached to a fingerprint reader or biometric sensor 10. Various embodiments also may have a display 12 (which may be color or monochrome, and low or high resolution), and means for input, such as a keypad or set of keys (which may be alphanumeric or telephone-style) 14. The display 12 may also be used as input means, if the display screen is touch sensitive. The display 12 may be based on liquid crystal display (LCD), organic light-emitting diode (OLED), or polymeric light-emitting diode (PLED) technology. Some exemplary embodiments may include one or more signal lights or LEDs to indicate operating or connection status 16.

In one exemplary embodiment, the isolated authentication device 2 is portable, and attaches or connects to, or is in electronic communication with, some host device (not shown). The host device may be a mobile telephone, a personal data or personal digital assistant (PDA), a GPS multifunction device, portable music player, wristband watch, a personal computer, or some similar device. The means for connection or communication 6 can be any one or more of standard means for connection or communication, including but not limited to a USB connector, a USB plug for wired USB connection, wireless network, infrared, smart card interface (contact or contactless), Bluetooth, Cardbus, or Ethernet. Thus, the isolated authentication device 2 may or may not be physically attached or connected to the host device. In one exemplary embodiment, the isolated authentication device 2 may be enclosed in the same casing as the host device, in which case a shell 4 may not be needed.

The isolated authentication device 2 contains a processor 22, which is capable of cryptographic functions. The device 2 also may possess general nonvolatile memory or RAM or volatile memory, or some combination thereof 24, and isolated nonvolatile memory (ROM or flash RAM) or other storage means or some combination thereof 26. A separate cryptoaccelerator and/or a separate communication controller (such as, but not limited to, a Universal Asynchronous Receiver/Transmitter, or UART) may be provided, although these functions may be incorporated into the processor 22. The device 2 also may contain a separate fingerprint or biometric device controller 28 or display controller 30, where these functions are not already incorporated in the processor 22. Some or all types of the above memory may be incorporated with the processor, and possibly with other of the above functions, on a single chip. A power source, such as a battery 32, also may be used 4.

FIG. 1 shows an exemplary embodiment of an isolated authentication device 2 with a fingerprint reader, USB connector and cap. The overall length of this exemplary embodiment is approximately 3 inches, width is approximately 0.75 inches, and thickness is approximately 0.31 inches. The size of other similar embodiments may vary.

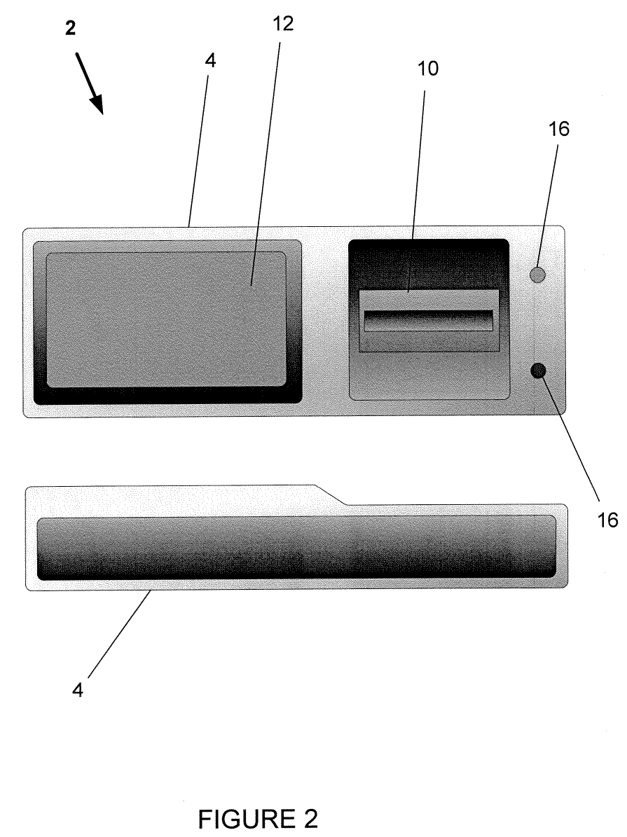

FIG. 2 shows another exemplary embodiment of an isolated authentication device with a fingerprint reader and display screen. Connection means may be wireless, Bluetooth, or infrared. The overall length of this exemplary embodiment is approximately 3.27 or 3.82 inches, width is approximately 1.14 or 1.18 inches, and thickness is approximately 0.62 inches. The size of other embodiments may vary.

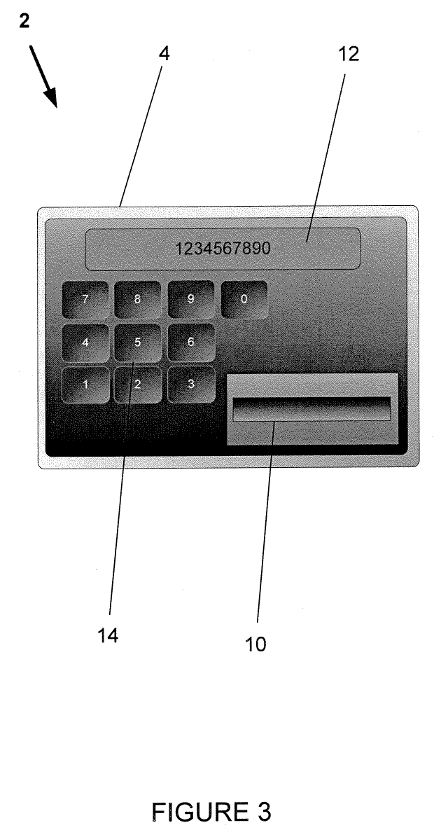

FIG. 3 shows another exemplary embodiment of an isolated authentication device with a fingerprint reader, numeric keypad and display screen. Connection means may be through a USB cable (not shown). The overall length of this exemplary embodiment is approximately 2.00 inches, and width is approximately 1.38 inches. The size of other embodiments may vary.

In one exemplary embodiment, the isolated authentication device 2 is run by a constrained operating system designed to eliminate or reduce the possibility of tampering or unauthorized access to files and instructions. The constrained operating system thus may provide only limited functions, including but not limited to taking input from the fingerprint reader or biometric sensor, taking input from the keypad, taking input from the display screen, releasing keys for internal use (after authentication of the user), and decryption/encryption operations. The constrained operating system cannot perform any general purpose operations, and excludes many typical operating system functions, such as application programming interfaces (APIs) and other facilities which serve to aid in programmability. Because the device 2 is designed to attach to or communicate with a host device that has its own multifunction operating system (such as for playing music, keeping calendars, providing email, and the like), there is no need for versatility in the device's 2 constrained operating system. For maximum security, the device 2 should not share a keypad, keyboard, fingerprint reader, biometric sensor, or display with the host device.

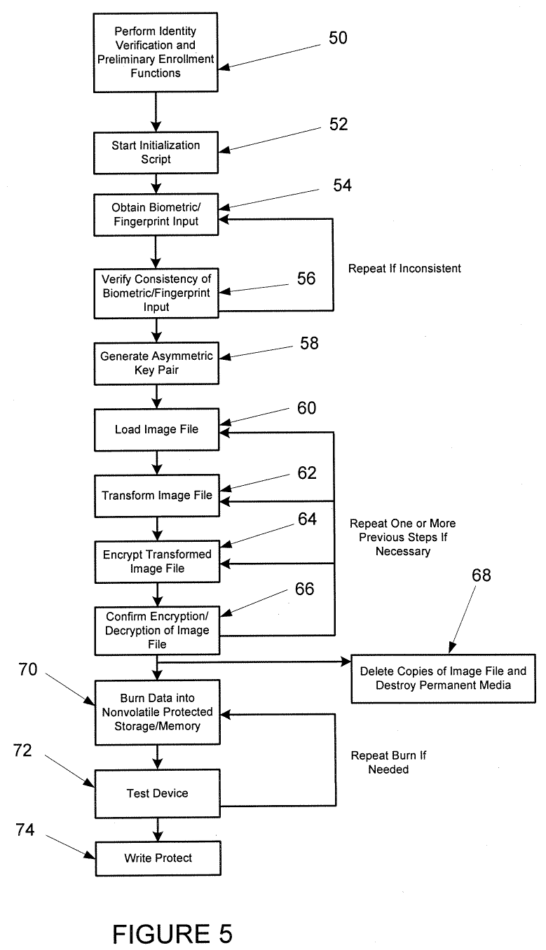

As shown in FIG. 5, use of the isolated authentication device 2 requires that it first be initialized. Initialization can be accomplished at a variety of computers or workstations. In an exemplary embodiment, initialization is accomplished at an enrollment workstation, which is a controlled-access personal computer. The enrollment workstation may be under the supervision of an enrollment officer. Where an enrollment officer is present, the enrollment officer performs any identity verification and other preliminary enrollment functions 50, and performs an initialization script 52 to produce files that will be transferred to the isolated authentication device 2. The enrollment officer takes input 54 from a fingerprint reader or biometric sensor attached to the enrollment workstation, and verifies that the fingerprint samples are consistent 56. In one exemplary embodiment, multiple samples are taken. In addition, the fingerprint reader or biometric sensor attached to the enrollment workstation may be identical or very similar in design to the fingerprint reader or biometric sensor in the isolated authentication device for greater accuracy and later efficiency. Upon verifying that fingerprint samples are consistent, the enrollment workstation is used to generate an asymmetric key pair 58 comprising a public key and a private key. If an enrollment officer is not present, some or all of the above steps may be taken by the individual user, or enrollee, or automatically using the script.

The individual user, or enrollee, then produces a confidential image file and loads said file into the enrollment workstation 60. If an enrollment officer was present for the earlier steps, the enrollment officer should leave for this and several subsequent steps. The enrollee should perform these steps independently, without being observed. These steps may be accomplished through a script running on the enrollment workstation.

A confidential image file typically was previously generated by the individual user. The user chooses or creates a simple, recognizable image, and saves it on an appropriate media (such as a compact disk, a USB memory stick or thumb drive, or similar portable information storage medium). If the image is created on paper or similar material, it may be scanned or otherwise converted into a standard electronic format.

After the confidential image file is loaded into the enrollment workstation, the software program in the workstation transforms the confidential image file into a file suitable for displaying on the isolated authentication device's display 62. In one exemplary embodiment, where the display is a low-resolution monochrome display, the confidential image file is transformed into a small, low-resolution monochrome file. The transformed confidential image file then is encrypted 64 using the previously-generated public key from the asymmetric key pair.

As a check, the initialization process may then decrypt the encrypted confidential image file using the private key from the key pair, and display the decrypted confidential image file on the enrollment workstation, to ensure that the encryption process was completed correctly 66.

Upon confirmation that the encryption process was completed correctly, all unencrypted versions of the confidential image file (and the original confidential image), both original and transformed, should be deleted, and all storage media on which a copy of the confidential image file was stored should be cleared or wiped 68. In the case of permanent media (such as a compact disk), the media is destroyed.

The next step is to attach the isolated authentication device 2 to the enrollment workstation, and burn 70 the asymmetric key pair, the user's fingerprint data (which may be encrypted), and the encrypted version of the confidential image file into the read-only or protected nonvolatile memory in the isolated authentication device 2. This step may be taken by the user, or by the enrollment officer, if any. Encrypted password and/or personal identification number (PIN) data also may be burned into the read-only or protected nonvolatile memory. The user then tests the isolated authentication device by performing various signing and encryption functions to ensure that the above data is correct 72. If not correct, this step may be repeated. Upon confirmation that the above data is correct and the device is properly functioning, the isolated authentication device may be write-protected by permanently removing a part of the internal circuit necessary for burning data into the read-only or nonvolatile memory 74. In one exemplary embodiment, this is accomplished by pulling on a tab. The initialization process is then complete, and the isolated authentication device 2 is ready for normal use and operation.

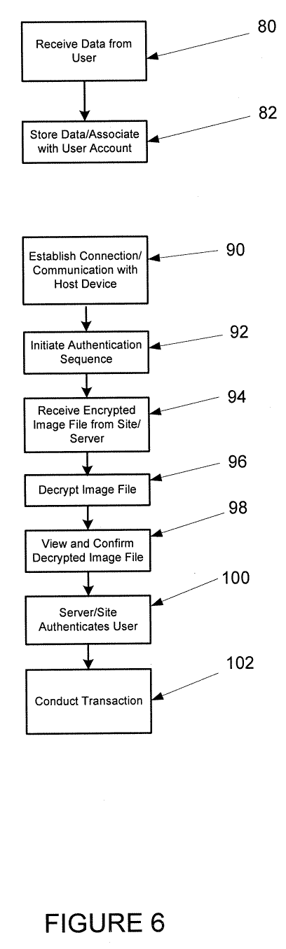

In operation, as seen in FIG. 6, the isolated authentication device 2 may be used to authenticate the identity of its user and establish the authenticity of Web sites, FTP site, servers, P2P clients, and other network resources. The user first provides his or her encrypted confidential image file to a party with which the user wishes to do business or otherwise communicate securely (the “server operator”) 80. The transfer may be performed in person, by postal mail, or by other offline or secure online means. The server operator loads or stores the encrypted confidential image file in a manner where said image file can be associated with that user 82. For example, the encrypted confidential image file may be loaded into a directory associated with the user's account. Similarly, encrypted password or PIN data may be provided.

When the user of the isolated authentication device 2 subsequently desires to communicate or do business with the server operator through a host device, such as a personal computer, the user first establishes a connection 90 between the host device and the isolated authentication device 2. The user then initiates the authentication sequence 92. This can be accomplished by entering a key or command sequence or pushing a button or switch on the isolated authentication device 2. This causes the appropriate encrypted confidential image file to be transferred 94 from the server to the user's isolated authentication device 2. The transfer may be accomplished using a tunneling protocol such as Secure Sockets Layer (SSL). The encrypted image file received from the server is decrypted 96 by the isolated authentication device 2 using the user's public key, and the decrypted file is displayed on the isolated authentication device 2. If the user recognizes 98 the displayed image as the one that was provided during the initiation or enrollment process, the user can be confident that the server or other device to which he or she is connected is one operated by the server owner who was originally provided with the encrypted confidential image file.

The server operator can also authenticate the identity of the user in several ways 100. The authentication may be two or three factor authentication (i.e., possession, fingerprint, and password or personal identification number).

Once both parties have been authenticated, the tunnel goes from the server to the isolated authentication device 2. The host device to which the isolated authentication device 2 is attached or is in communication with may be given information that has been transferred over the connection 102. No image, password, PIN, or biometric information that is unencrypted ever leaves the isolated authentication device 2, which is controlled by the constrained operating system.

The constrained operating system manages all the functions of the isolated authentication device 2. These functions include authentication functions, such as verifying that a fingerprint from an attached or incorporated fingerprint reader matches the fingerprint contained in internal nonvolatile memory, and receiving and verifying a PIN or password entered on the attached or incorporated keypad. Another function is data transfer, including receiving data from and sending data to properly authenticated entities (such as a host device or remote device or server), and exporting the public key. The constrained operating system also performs a variety of cryptographic functions, including performing hash functions on files provided to it by a properly authenticated entity, encrypting small files (such as hashes) using its private key, producing a symmetric session key when asked to do so by a properly authenticated entity, receiving a symmetric session key produced by a properly authenticated entity, and performing symmetric encryption and decryption functions.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. An authentication device, comprising:
a processor capable of performing cryptographic functions;
means for storing biometric data about a user of the authentication device, said storage means in electronic communication with said processor;
a biometric sensor for reading biometric data from a user of the authentication device;
means for connecting to or communicating with a host device; and
a constrained operating system with limited functions.

2. The authentication device of claim 1, further comprising display means.

3. The authentication device of claim 1, further comprising input means.

4. The authentication device of claim 1, further comprising a shell for containing the processor and storage means.

5. The authentication device of claim 1, further comprising one or more indicator lights.

6. The authentication device of claim 1, further comprising general nonvolatile memory.

7. The authentication device of claim 1, further comprising a power source.

8. The authentication device of claim 1, wherein the biometric sensor is a fingerprint reader.

9. The authentication device of claim 1, wherein the connection or communications means comprise a Universal Serial Bus connector or plug.

10. The authentication device of claim 1, wherein the connection or communications means are wireless.

11. The authentication device of claim 3, wherein the input means is a numeric or alphanumeric keypad.

12. A method for using an authentication device, comprising the steps of:
establishing a wired or wireless connection between the authentication device and a host device;
receiving the encrypted file of an image from a server or entity to be authenticated;
decrypting the image file; and
displaying the image file.

13. The method of claim 12, further comprising the steps of:
obtaining fingerprint data from a user through a fingerprint reader on or connected to the authentication device; and
comparing that fingerprint data to previous fingerprint data from the user stored in the authentication device.

14. The method of claim 12, further comprising the steps of:
obtaining password or personal identification number input from a user through input means on the authentication device; and
comparing that password or personal identification number input to previous password or personal identification number data from the user stored in the authentication device.

15. The method of claim 12, wherein the encrypted file of an image was previously provided to the server or entity to be authenticated by the user of the authentication device.

16. A method for initializing an authentication device, comprising the steps of:
obtaining multiple fingerprint sample data from the user of the authentication device;
generating an asymmetric key pair comprising a public key and a private key;
transforming a file of an image into a image file suitable for display on the authentication device;
encrypting the transformed image file using the public key from the asymmetric key pair; and
burning the asymmetric key pair data, fingerprint data, and encrypted transformed image file into the read-only or protected nonvolatile memory of the authentication device.

17. The method of claim 16, further comprising the step of:
destroying or deleting all unencrypted versions of the image file, and any permanent media on which a version of the image file was stored.

18. The method of claim 16, further comprising the step of:
causing the read-only or protected nonvolatile memory to be write-protected by removing part of the internal circuit necessary for burning the read-only or protected nonvolatile memory.

19. The method of claim 16, further comprising the steps of:
encrypting password or personal identification number data from the user using the public key from the asymmetric key pair; and
burning the encrypted password or personal identification number data into the read-only or protected nonvolatile memory of the authentication device.
